(19) United States
(12) Patent Application Publication
(10) Pub. No.: US 2008/0023329 A1
(43) Pub. Date: Jan. 31, 2008

(54) Exhaust gas sensor having a conductive shield and method for routing mobile ions to a contact pad utilizing the conductive shield

(76) Inventors: Lora B. Thrun, Flushing, MI (US); Eric P. Clyde, Bay City, MI (US); Walter T. Symons, Grand Blanc, MI (US); Gene A. Mausolf, Swartz Creek, MI (US)

Correspondence Address: DELPHI TECHNOLOGIES, INC., M/C 480-410-202, PO BOX 5052, TROY, MI, 48007, US

(21) Appl. No.: 11/496,125

(22) Filed: Jul. 31, 2006

(51) Int. Cl. G01N 27/26

(52) U.S. Cl. 204/424

(57) ABSTRACT

A conductive shield for routing mobile ions to contact pad in accordance with an exemplary embodiment is provided. The conductive shield includes a first conductive path electrically coupled to the contact pad. The conductive shield further includes a second conductive path electrically coupled to first and second locations on the first conductive path such that when a physical break occurs in the first conductive path between the first and second locations, mobile ions in the first conductive path are still routed to the contact pad through the second conductive path.

### TECHNICAL FIELD

An exhaust gas sensor having a conductive shield and a method for routing mobile ions to a contact pad utilizing the conductive shield are provided.

### BACKGROUND

Internal combustion engines produce exhaust gas constituents including oxygen, carbon dioxide, hydrocarbons, and nitrogen oxides as well as other gases. The automotive industry has utilized various exhaust gas sensors for determining the concentration of exhaust gas constituents contained in an exhaust stream.

One type of exhaust gas sensor employs an electrochemical cell to either pump a particular gas constituent out of an exhaust stream or to sense a particular amount of a gas constituent in an exhaust stream. These sensors are often constructed out of materials such as alumina and zirconia. In order to facilitate the electrochemical reactions in these sensors, a heater is typically utilized to maintain the sensor at a proper operating temperature. The voltage applied to the heating circuit produces regions of positive and negative polarity along the heater. When the exhaust gas sensor is heated, mobile ions present in the alumina and zirconia migrate towards the heater. The negative ions migrate towards regions of positive polarity, while the positive ions migrate towards regions of negative polarity or ground. A buildup of ions, typically positive ions, proximate to the heater can degrade the performance of the heater resulting in a possible malfunction of the exhaust gas sensor.

One way to prevent the buildup of positively charged ions proximate the heater involves placing a single conductive path in a spaced relationship from the electrochemical cell and the heater. The single conductive path attracts mobile ions away from the heater. The single conductive path, however, can suffer from print defects such as a physical break therein causing a substantial part of the single conductive path to no longer attract positive mobile ions. Once this happens, the positive ions will begin to buildup proximate the heater degrading the performance of the heater and resulting in a possible malfunction of the exhaust gas sensor.

Therefore, the inventors have recognized a need for a shield that will continue to route positive ions away from the heater even when a physical break occurs in the shield.

### SUMMARY OF THE INVENTION

An exhaust gas sensor in accordance with an exemplary embodiment is provided. The exhaust gas sensor includes an electrochemical cell. The exhaust gas sensor further includes an electrical heater. The exhaust gas sensor further includes a conductive shield disposed between the electrochemical cell and the electrical heater. The conductive shield is configured to route mobile ions flowing proximate the electrical heater away from the electrical heater to a contact pad electrically coupled to the conductive shield. The contact pad has a lowest electrical potential in the exhaust gas sensor. The conductive shield includes a first conductive path electrically coupled to the contact pad. The conductive shield further includes a second conductive path electrically coupled to first and second locations on the first conductive path such that when a physical break occurs in the first conductive path between the first and second locations, mobile ions in the first conductive path are still routed to the contact pad through the second conductive path.

A conductive shield in accordance with another exemplary embodiment is provided. The conductive shield includes a first conductive path configured to be electrically coupled to a contact pad of an exhaust gas sensor. The conductive shield further includes a second conductive path electrically coupled to first and second locations on the first conductive path such that when a physical break occurs in the first conductive path between the first and second locations, mobile ions in the first conductive path are still routed to the contact pad through the second conductive path.

A method for manufacturing a conductive shield of an exhaust gas sensor in accordance with another exemplary embodiment is provided. The method includes forming a first conductive path on a first substrate layer of the exhaust gas sensor, the first conductive path being electrically coupled to a contact pad. The method further includes forming a second conductive path on the first substrate layer of the exhaust gas sensor, the second conductive path being electrically coupled to first and second locations on the first conductive path such that when a physical break occurs in the first conductive path between the first and second locations, mobile ions in the first conductive path are still routed to the contact pad through the second conductive path.

A method for controlling an amount of mobile ions migrating toward an electrical heater in an exhaust gas sensor in accordance with another exemplary embodiment is provided. The exhaust gas sensor includes an electrochemical cell. The exhaust gas sensor further includes an electrical heater. The exhaust gas sensor further includes a conductive shield disposed between the electrochemical cell and the electrical heater. The conductive shield has a first conductive path electrically coupled to the contact pad. The conductive shield also has a second conductive path electrically coupled to first and second locations on the first conductive path. The method includes supplying a first electrical potential to the contact pad. The first electrical potential is a lowest potential in the exhaust gas sensor. The method further includes routing mobile ions flowing proximate the electrical heater away from the electrical heater through the second conductive path to the contact pad even when a physical break occurs in the first conductive path.

### BRIEF DESCRIPTION OF THE DRAWINGS

FIG. 1 is a schematic of an exhaust gas sensor and a control circuit for controlling operation of the exhaust gas sensor in accordance with an exemplary embodiment of the invention;

FIG. 2 is a top view of the conductive shield utilized in the exhaust gas sensor of FIG. 1;

FIG. 3 is an expanded view of a portion of the conductive shield in FIG. 2;

FIG. 4 is a flow chart of a method for manufacturing the conductive shield utilized in the exhaust gas sensor of FIG. 1;

FIG. 5 is a flow chart of a method for controlling an amount of mobile ions migrating toward an electrical heater in the exhaust gas sensor of FIG. 1.

### DETAILED DESCRIPTION OF EXEMPLARY EMBODIMENTS

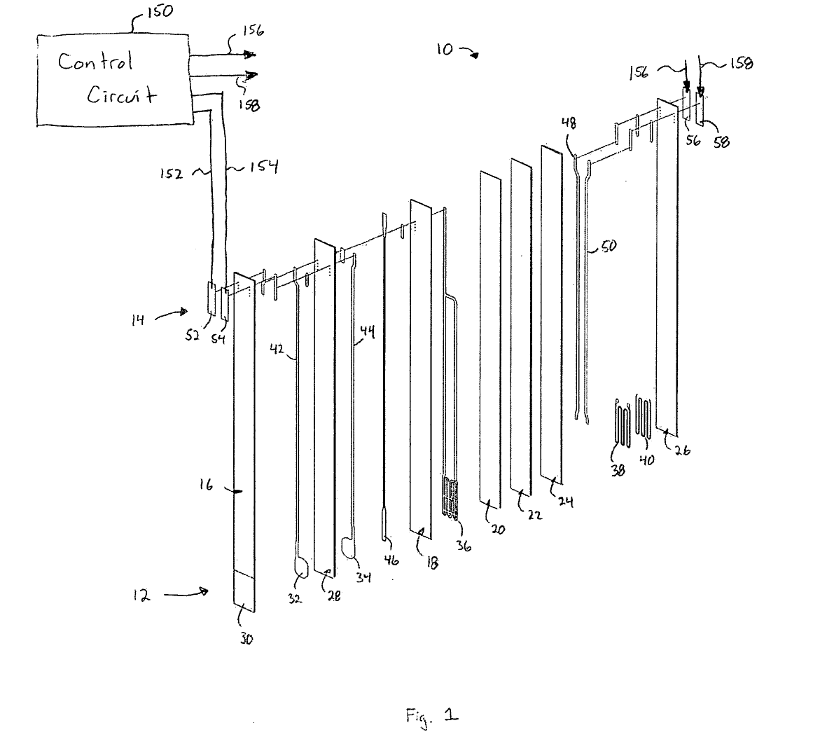

Referring to FIG. 1, an exhaust gas sensor 10 and a control circuit 150 for controlling operation of the exhaust gas sensor 10 is shown. The exhaust gas sensor 10 utilizes a conductive shield 36 in accordance with an exemplary embodiment. It should be noted that the conductive shield 36 can be utilized in any type of exhaust gas sensor that can measure one or more exhaust gas constituents, such as oxygen or ammonia for example.

The exhaust gas sensor 10 is provided to generate a signal indicative of whether an exhaust stream has an air/fuel ratio that is above or below a stoichiometric air/fuel ratio. The stoichiometric air/fuel ratio is the chemically optimal point where the fuel and oxygen balance each other out during the fuel combustion process. The exhaust gas sensor 10 has a sensing end 12 and a terminal end 14. The exhaust gas sensor 10 includes substrate layers 16, 18, 20, 22, 24, 26, an active layer 28, electrodes 32, 34, a conductive shield 36, heating coils 38, 40, sensor leads 42, 44, a reference gas channel 46, heater leads 48, 50, and contact pads 52, 54, 56, 58.

The substrate layers 16, 18, 20, 22, 24, 26 provide structural integrity for the exhaust gas sensor 10 and also insulate sensor components from electrical and ionic conduction. The active layer 28 is provided to conduct oxygen ions between the measurement gas and the reference gas. The active layer 28 is disposed between substrate layers 16 and 18. Substrate layers 16, 18, 20, 22, 24, 26 are constructed out of an insulating material, such as alumina for example. A porous protective layer 30 is disposed on the sensing end 12 of the substrate layer 16. The porous protective layer 30 allows electrode 32 to be exposed to the exhaust gas stream. The active layer 28 is constructed out of an ionically conductive solid electrolyte material, such as yttria stabilized zirconia for example.

The electrodes 32, 34 and sensor leads 42, 44 are provided to detect an electrical potential between opposing surfaces of the active layer 28. Electrode 32 is disposed between substrate layer 16 and active layer 28, and electrode 34 is disposed between substrate layer 18 and active layer 28. Electrode 32 can be constructed using a porous platinum electrode configured to expose the exterior surface of active layer 28 to an exhaust gas. Similarly, electrode 34 can be constructed using a porous platinum electrode configured to expose the interior surface of active layer 28 to a reference gas. Electrode 32 is electrically coupled to sensor lead 42 and contact pad 52. Electrode 34 is electrically coupled to sensor lead 44 and contact pad 54.

The electrodes 32, 34 and the active layer 28 form an electrochemical cell configured to measure the oxygen concentration in an exhaust stream relative to the oxygen concentration of a reference gas (typically ambient air). When opposite surfaces of the electrochemical cell are exposed to different oxygen partial pressures, an electromotive force is induced between the electrodes 32, 34. The relationship between the oxygen partial pressures and the electromotive force is described by the Nernst equation:

$$EMF = ( \frac{- RT}{4 F} ) ln ( \frac{{P}_{{O}_{2}}^{ref}}{{P}_{{O}_{2}}} )$$

where: EMF=electromotive force
R=universal gas constant
F=Faraday constant
T=absolute temperature of the gas
P_{O}_{₂}^{ref}=oxygen partial pressure of the reference gas
P_{O}_{₂}=oxygen partial pressure of the exhaust gas

The conductive shield 36 is provided to route mobile ions towards a contact pad 52 configured to have a lowest electrical potential in the exhaust gas sensor 10. In an exemplary embodiment, the conductive shield 36 is disposed between substrate layers 18 and 20 and is electrically coupled to contact pad 52 and sensor lead 42. It should be recognized that in other embodiments of this invention, the conductive shield 36 can be electrically coupled to any of the other contact pads 52, 54, 56, 58 or a contact pad dedicated solely for the conductive shield 36 provided the contact pad has a lowest electrical potential in the exhaust gas sensor 10. In an exemplary embodiment, the conductive shield 36 is made of a conductive material such as platinum.

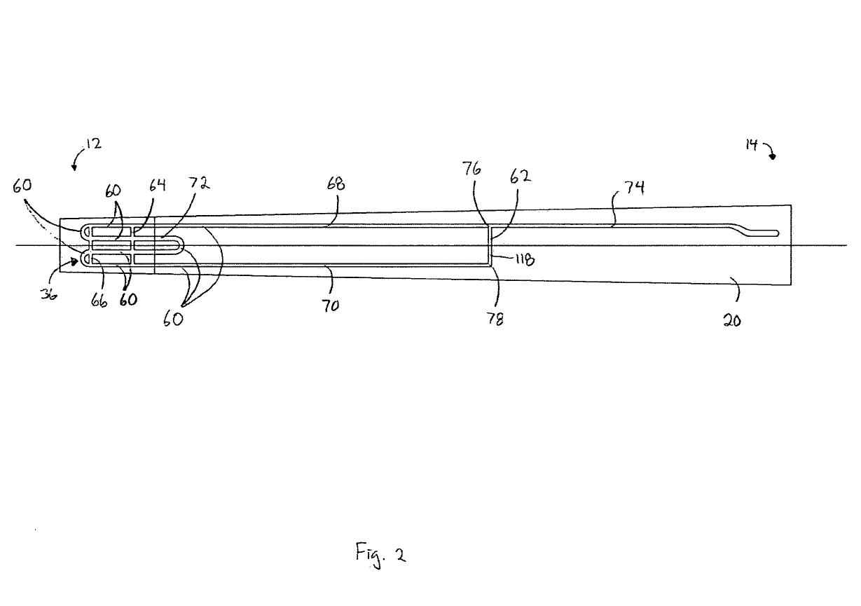

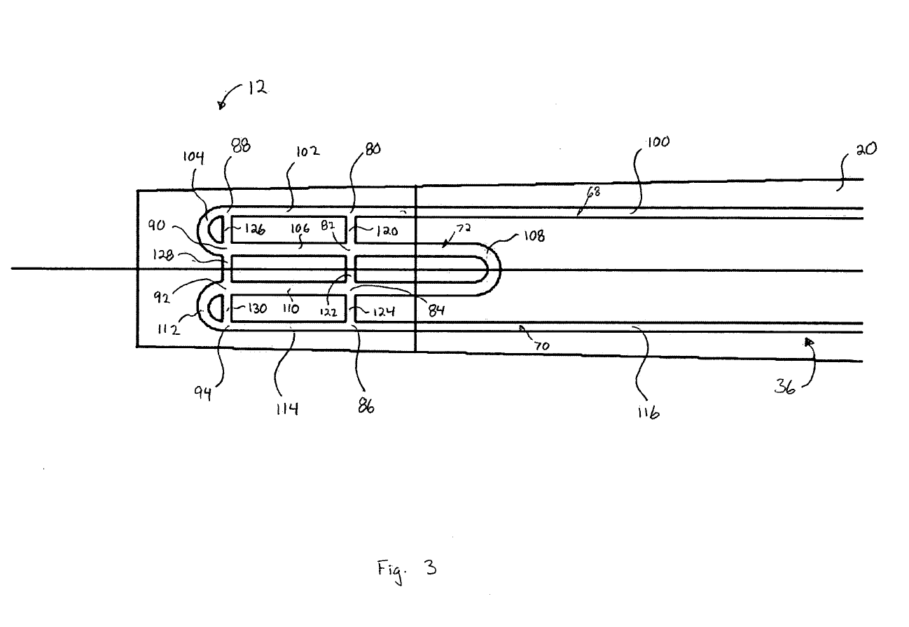

Referring to FIGS. 2 and 3, a top view and an expanded view of the conductive shield 36 utilized in the exhaust gas sensor of FIG. 1 are shown. The conductive shield includes conductive paths 60, 62, 64, 66 and a lead 74.

The conductive paths 60, 62, 64, 66 are provided to route mobile ions to lead 74, which is electrically coupled to contact pad 52. In an exemplary embodiment, the conductive paths 60, 62, 64, 66 may be formed by screen printing the conductive paths onto substrate layer 20.

Conductive path 60 includes conductive portions 68, 70, 72. Conductive portion 68 includes segments 100 and 102. Conductive portion 70 includes segments 114 and 116. Conductive portion 72 includes segments 104, 106, 108, 110 and 112. Conductive path 62 includes segment 118. Conductive path 64 includes segments 120, 122 and 124. Conductive path 66 includes segments 126, 128, and 130.

Conductive portion 68 is electrically coupled to: (i) lead 74 at location 76, (ii) conductive path 62 at location 76, (iii) conductive path 64 at location 80, (iv) conductive path 66 at location 88, and (v) conductive portion 72 at location 88.

Conductive portion 70 is electrically coupled to: (i) conductive path 62 at location 78, (ii) conductive path 64 at location 86, (iii) conductive path 66 at location 94, and (iv) conductive portion 72 at location 94.

Conductive portion 72 is electrically coupled to: (i) conductive portion 68 at location 88, (ii) conductive path 66 at locations 88 and 94, and (iii) conductive portion 70 at locations 94. In an exemplary embodiment, conductive portion 72 may have a serpentine shape with a profile similar to the heater coils 38, 40 of the exhaust gas sensor 10. When conductive portion 72 has a serpentine shape, it may also intersect and be electrically coupled to: (i) conductive path 64 at locations 82 and 84, and (ii) conductive path 66 at locations 90 and 92.

Conductive path 62 is provided to route mobile ions towards contact pad 52 even when a physical break occurs in conductive path 60 between locations 76 and 78. Conductive path 62 is electrically coupled to conductive path 60 at locations 76 and 78.

Conductive path 64 is provided to route mobile ions towards contact pad 52 even when a physical break occurs in conductive path 60 between locations 80 and 86. Conductive path 64 is electrically coupled to conductive path 60 at locations 80 and 86. In an exemplary embodiment, conductive path 64 may also intersect conductive path 60 at locations 82 and 84.

Conductive path 66 is provided to route mobile ions towards contact pad 52 even when a physical break occurs in conductive path 60 between locations 88 and 94. Conductive path 66 is electrically coupled to conductive path 60 at locations 88 and 94. In an exemplary embodiment, conductive path 66 may also intersect conductive path 60 at locations 90 and 92.

It should be recognized that other embodiments of this invention could include more or less conductive paths arranged in similar or different configurations such that when a break occurs in one conductive path, mobile ions are still routed towards a contact pad by means of additional conductive paths. Moreover, the conductive paths may take on similar or different shapes and sizes and be comprised of more or less segments.

The lead 74 is provided to electrically couple the conductive shield to contact pad 52, which has a lowest electrical potential in the exhaust gas sensor 10. Referring to FIG. 1, lead 74 is electrically coupled to contact pad 52 and lead 42 of electrode 32. It should be recognized that in other embodiments of this invention, lead 74 may be electrically coupled to another sensor electrode, such as electrode 34, or the lead 74 may not be electrically coupled to any sensor electrode.

Referring again to FIG. 1, the heating coils 38, 40 and heater leads 48, 50 are provided to maintain the sensing end 12 of the exhaust gas sensor 10 at a selected operating temperature sufficient to facilitate the various electrochemical reactions therein. Heating coil 38 is electrically coupled to heater lead 48 and contact pad 56. Heating coil 40 is electrically coupled to heater lead 50 and contact pad 58.

The reference gas channel 46 is provided to route a reference gas, such as ambient air, into the exhaust gas sensor 10 so that electrode 34 and the interior surface of the active layer 28 may be exposed to the reference gas. The reference gas channel 46 can be formed by screen printing the channel using a fugitive ink and subsequently burning the ink away during a sintering process.

The control circuit 150 is provided to control the operation of the heating coils 38, 40 and the electrodes 32, 34. The control circuit 150 controls the heating coils 38, 40 by applying a voltage across electrical lines 156 and 158. The voltage is transmitted to contact pads 56, 58 and subsequently to heater leads 48, 50. In an exemplary embodiment, the control circuit 150 also applies a voltage to electrode 32 and measures the electrical potential (emf) between electrodes 32 and 34 utilizing electrical lines 152, 154. The measured electrical potential is indicative of the oxygen concentration in an exhaust stream relative to the oxygen concentration of a reference gas.

The control circuit 150 also supplies an electrical potential to conductive shield 36 through electrical line 152. This electrical potential is configured to be a lowest electrical potential in the exhaust gas sensor 10. In exemplary embodiments, the electrical potential may be a negative electrical potential or a ground level electrical potential.

Contact pads 52, 54 and electrical lines 152, 154 are provided to transfer signals between the control circuit 150 and the exhaust gas sensor 10. Contact pad 52 is electrically coupled to lead 42, conductive shield 36, and electrical line 152. Contact pad 54 is electrically coupled to lead 44 and electrical line 154.

Contact pads 56, 58 and electrical lines 156, 158 are provided to transfer signals from the control circuit 150 to the heating coils 38, 40 inside the exhaust gas sensor 10. Contact pad 56 is electrically coupled to lead 48 and electrical line 156. Contact pad 58 is electrically coupled to lead 50 and electrical line 158.

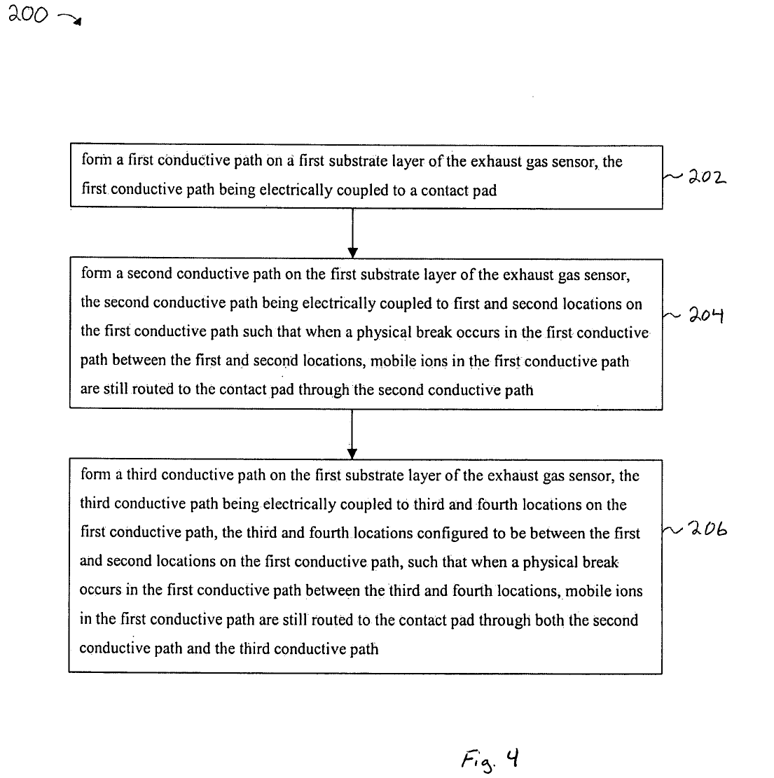

Referring to FIG. 4, a method for manufacturing a conductive shield 36 of an exhaust gas sensor 10 will now be described.

At step 202, a first conductive path 60 is formed on a first substrate layer 20 of the exhaust gas sensor 10. The first conductive path 60 is electrically coupled to a contact pad 52.

At step 204, a second conductive path 62 is formed on the first substrate layer 20 of the exhaust gas sensor 10. The second conductive path 62 is electrically coupled to first and second locations 76, 78 on the first conductive path 60 such that when a physical break occurs in the first conductive path 60 between the first and second locations 76, 78, mobile ions in the first conductive path 60 are still routed to the contact pad 52 through the second conductive path 62.

At step 206, a third conductive path 64 is formed on the first substrate layer 20 of the exhaust gas sensor 10. The third conductive path 64 is electrically coupled to third and fourth locations 80, 86 on the first conductive path 60. The third and fourth locations 80, 86 are configured to be between the first and second locations 76, 78 on the first conductive path 60, such that when a physical break occurs in the first conductive path 60 between the third and fourth locations 80, 86, mobile ions in the first conductive path 60 are still routed to the contact pad 52 through both the second conductive path 62 and the third conductive path 64.

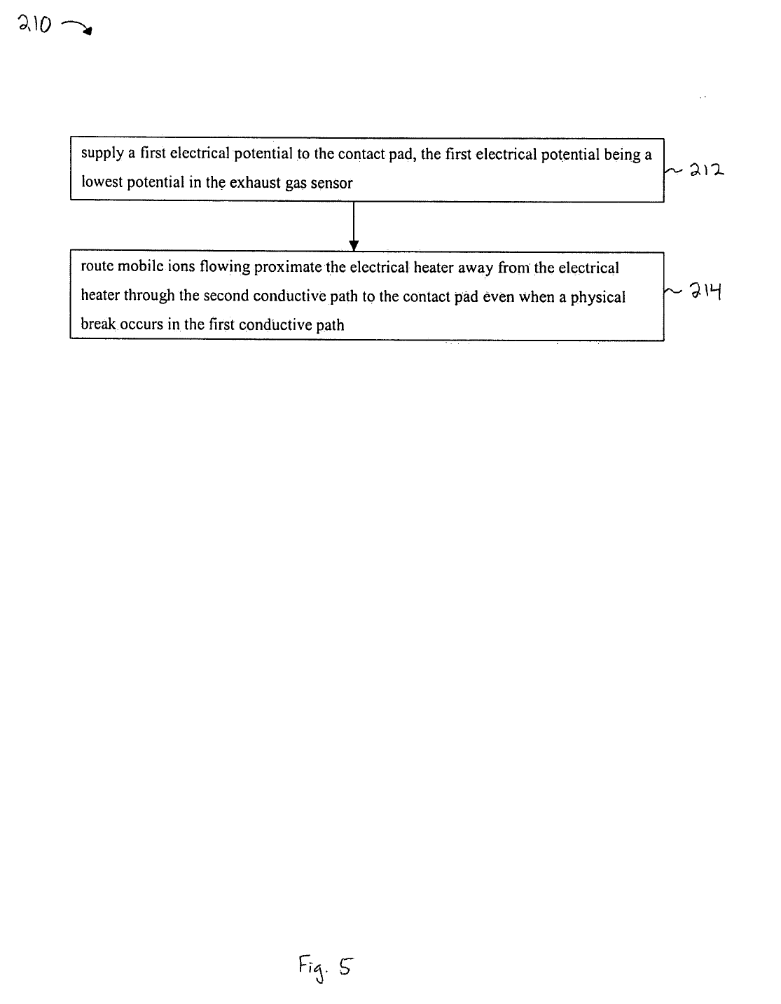

Referring to FIG. 5, a method 210 for controlling an amount of mobile ions migrating toward an electrical heater 38, 40 in the exhaust gas sensor 10 will now be described.

At step 212, a first electrical potential is supplied to the contact pad 52, the first electrical potential being a lowest potential in the exhaust gas sensor.

At step 214, the conductive shield 36 routes mobile ions flowing proximate the electrical heater 38, 40 away from the electrical heater 38, 40 through the second conductive path 62 to the contact pad 52 even when a physical break occurs in the first conductive path 60.

The exhaust gas sensor 10 having the conductive shield 36 provides a substantial advantage over other exhaust gas sensors. In particular, the exhaust gas sensor 10 provides a technical effect of utilizing a conductive shield 36 having multiple conductive paths to route positive ions away from an internal heater and towards a contact pad 52 even when a physical break occurs in the conductive shield 36.

While embodiments of the invention are described with reference to the exemplary embodiments, it will be understood by those skilled in the art that various changes may be made and equivalents may be substituted for elements thereof without departing from the scope of the invention. In addition, many modifications may be made to the teachings of the invention to adapt to a particular situation without departing from the scope thereof. Therefore, it is intended that the invention not be limited to the embodiment disclosed for carrying out this invention, but that the invention includes all embodiments falling within the scope of the intended claims. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

What is claimed is:

1. An exhaust gas sensor, comprising:
an electrochemical cell;
an electrical heater; and
a conductive shield disposed between the electrochemical cell and the electrical heater, the conductive shield configured to route mobile ions flowing proximate the electrical heater away from the electrical heater to a contact pad electrically coupled to the conductive shield, the contact pad having a lowest electrical potential in the exhaust gas sensor, the conductive shield having a first conductive path electrically coupled to the contact pad, and a second conductive path electrically coupled to first and second locations on the first conductive path such that when a physical break occurs in the first conductive path between the first and second locations, mobile ions in the first conductive path are still routed to the contact pad through the second conductive path.

2. The exhaust gas sensor of claim 1 wherein the conductive shield further comprises a third conductive path electrically coupled to third and fourth locations on the first conductive path, the third and fourth locations configured to be between the first and second locations on the first conductive path, such that when a physical break occurs in the first conductive path between the third and fourth locations, mobile ions in the first conductive path are still routed to the contact pad through both the second conductive path and the third conductive path.

3. The exhaust gas sensor of claim 1 wherein the first conductive path of the conductive shield further comprises a first conductive portion, a second conductive portion positioned in a spaced relationship with the first conductive portion, and a third conductive portion electrically coupled to the first conductive portion and the second conductive portion such that the first location of the first conductive path is located on the first conductive portion and the second location of the first conductive path is located on the second conductive portion.

4. The exhaust gas sensor of claim 3 wherein the third conductive portion of the first conductive path has a serpentine shape.

5. The exhaust gas sensor of claim 3 wherein the conductive shield further comprises a third conductive path electrically coupled to third and fourth locations on the first conductive path, the third and fourth locations configured to be between the first and second locations on the first conductive path such that when a physical break occurs in the first conductive path between the third and fourth locations, mobile ions in the first conductive path are still routed to the contact pad through both the second conductive path and the third conductive path, wherein the third conductive path intersects the third conductive portion of the first conductive path.

6. The exhaust gas sensor of claim 1 wherein the electrochemical cell comprises a first electrode, a second electrode, and an electrolyte disposed between the first electrode and the second electrode.

7. The exhaust gas sensor of claim 6 wherein the second electrode of the electrochemical cell and the conductive shield are in electrical communication with each other.

8. The exhaust gas sensor of claim 1 further comprising a first substrate layer on which the conductive shield is printed.

9. The exhaust gas sensor of claim 8 further comprising a second substrate layer disposed between the electrochemical cell and the conductive shield.

10. A conductive shield, comprising:
a first conductive path configured to be electrically coupled to a contact pad of an exhaust gas sensor; and
a second conductive path electrically coupled to first and second locations on the first conductive path such that when a physical break occurs in the first conductive path between the first and second locations, mobile ions in the first conductive path are still routed to the contact pad through the second conductive path.

11. The conductive shield of claim 10 further comprising a third conductive path electrically coupled to third and fourth locations on the first conductive path, the third and fourth locations configured to be between the first and second locations on the first conductive path, such that when a physical break occurs in the first conductive path between the third and fourth locations, mobile ions in the first conductive path are still routed to the contact pad through both the second conductive path and the third conductive path.

12. The conductive shield of claim 10 wherein the first conductive path further comprises a first conductive portion, a second conductive portion positioned in a spaced relationship with the first conductive portion, and a third conductive portion electrically coupled to the first conductive portion and the second conductive portion such that the first location of the first conductive path is located on the first conductive portion and the second location of the first conductive path is located on the second conductive portion.

13. The conductive shield of claim 12 wherein the third conductive portion of the first conductive path has a serpentine shape.

14. The conductive shield of claim 12 further comprising a third conductive path electrically coupled to third and fourth locations on the first conductive path, the third and fourth locations configured to be between the first and second locations on the first conductive path such that when a physical break occurs in the first conductive path between the third and fourth locations, mobile ions in the first conductive path are still routed to the contact pad through both the second conductive path and the third conductive path, wherein the third conductive path intersects the third conductive portion of the first conductive path.

15. The conductive shield of claim 10 further comprising a first substrate layer on which the first conductive path and the second conductive path are printed.

16. A method for manufacturing a conductive shield of an exhaust gas sensor, comprising:
forming a first conductive path on a first substrate layer of the exhaust gas sensor, the first conductive path being electrically coupled to a contact pad; and
forming a second conductive path on the first substrate layer of the exhaust gas sensor, the second conductive path being electrically coupled to first and second locations on the first conductive path such that when a physical break occurs in the first conductive path between the first and second locations, mobile ions in the first conductive path are still routed to the contact pad through the second conductive path.

17. The method of claim 16 further comprising:
forming a third conductive path on the first substrate layer of the exhaust gas sensor, the third conductive path being electrically coupled to third and fourth locations on the first conductive path, the third and fourth locations configured to be between the first and second locations on the first conductive path, such that when a physical break occurs in the first conductive path between the third and fourth locations, mobile ions in the first conductive path are still routed to the contact pad through both the second conductive path and the third conductive path.

18. A method for controlling an amount of mobile ions migrating toward an electrical heater in an exhaust gas sensor, the exhaust gas sensor having an electrochemical cell, an electrical heater, and a conductive shield disposed between the electrochemical cell and the electrical heater, the conductive shield having a first conductive path electrically coupled to a contact pad, and a second conductive path electrically coupled to first and second locations on the first conductive path:
supplying a first electrical potential to the contact pad of the exhaust gas sensor, the first electrical potential being a lowest potential in the exhaust gas sensor; and
routing mobile ions flowing proximate the electrical heater away from the electrical heater through the second conductive path to the contact pad even when a physical break occurs in the first conductive path.
